(19) United States
(12) Patent Application Publication
(10) Pub. No.: US 2023/0147655 A1
(43) Pub. Date: May 11, 2023

(54) MACHINE TOOL

(71) Applicant: FANUC CORPORATION, Yamanashi (JP)

(72) Inventor: Chikara TANGO, Yamanashi-ken (JP)

(21) Appl. No.: 17/918,632

(22) PCT Filed: Apr. 12, 2021
(86) PCT No.: PCT/JP2021/015115

§ 371 Date: Oct. 13, 2022

(30) Foreign Application Priority Data
Apr. 17, 2020 (JP) 2020-073880

(51) Int. Cl. B23B 3/06

(52) U.S. Cl. CPC B23B 3/06

(57) ABSTRACT

The present invention provides a machine tool in which drops in lathe precision can be prevented and the angle of rotation of a lathe tool can be set. The machine tool comprises: a spindle head to which a spindle is provided: a tool holder which holds the lathe tool and is mounted on the spindle; a securing member, provided to the spindle head, for securing the lathe tool while allowing adjustment of the angle of rotation of the lathe tool: and an attachment member, provided to the tool holder, for attaching the lathe tool to the securing member at an adjusted angle of rotation, wherein the angle of rotation of the lathe tool is adjusted in accordance with where on the securing member the attachment member is attached.

### TECHNICAL FIELD

The present invention relates to a machine tool.

### BACKGROUND ART

JP 2018-034248 A discloses a machine tool that machines a workpiece by causing a spindle head to move relative to a table while rotating a spindle on which a cutting tool is mounted.

### SUMMARY OF THE INVENTION

It is desirable to perform a turning process using the machine tool as disclosed in JP 2018-034248 A. The machine tool that carries out the turning process rotates the workpiece while the spindle on which a lathe machining tool is installed is non-rotatably fixed by stopping the operation of a motor. However, the spindle is originally configured in a manner so as to rotate. Therefore, in the machine tool that carries out the turning process, even if the spindle is fixed by the motor, the lathe machining tool that is in contact with the workpiece at the time of the turning process can easily move in the direction of rotation of the spindle. If the lathe machining tool moves during machining, the machining accuracy decreases.

An object of the present invention is to provide a machine tool, which is capable of preventing a decrease in the accuracy of a turning process, and is also capable of setting an angle of rotation of the lathe machining tool.

A machine tool according to one aspect of the present invention includes a spindle head equipped with a spindle, a tool holder that is configured to retain a lathe machining tool and is installed on the spindle, a fixing member provided on the spindle head and configured to fix the lathe machining tool while enabling an angle of rotation of the lathe machining tool to be adjusted, and a mounting member provided on the tool holder and configured to mount the lathe machining tool on the fixing member at the angle of rotation that has been adjusted, wherein the angle of rotation of the lathe machining tool is adjusted in accordance with a location on the fixing member where the mounting member is mounted.

According to the present invention, it is possible to provide the machine tool, which is capable of preventing a decrease in the accuracy of the turning process, and is also capable of setting an angle of rotation of the lathe machining tool.

### BRIEF DESCRIPTION OF DRAWINGS

FIG. 1 is a side view showing a machine tool according to a first embodiment of the present invention;

FIG. 2 is a perspective view showing a portion of the machine tool according to the first embodiment;

FIG. 3 is a side view showing a portion of the machine tool according to the first embodiment;

FIG. 4 is a side view showing a portion of the machine tool according to the first embodiment;

FIG. 5 is a perspective view showing a portion of a machine tool according to a second embodiment;

FIG. 6 is a side view showing a portion of the machine tool according to the second embodiment;

FIG. 7 is a side view showing a portion of the machine tool according to the second embodiment;

FIG. 8 is a perspective view showing a portion of a machine tool according to a third embodiment;

FIG. 9 is a side view showing a portion of the machine tool according to the third embodiment;

FIG. 10 is a side view showing a portion of the machine tool according to the third embodiment;

FIG. 11 is a side view showing a portion of a machine tool according to a fourth embodiment; and

FIG. 12 is a side view showing a portion of the machine tool according to the fourth embodiment.

### DESCRIPTION OF THE INVENTION

Preferred embodiments of a machine tool according to the present invention will be presented and described in detail below with reference to the accompanying drawings.

### First Embodiment

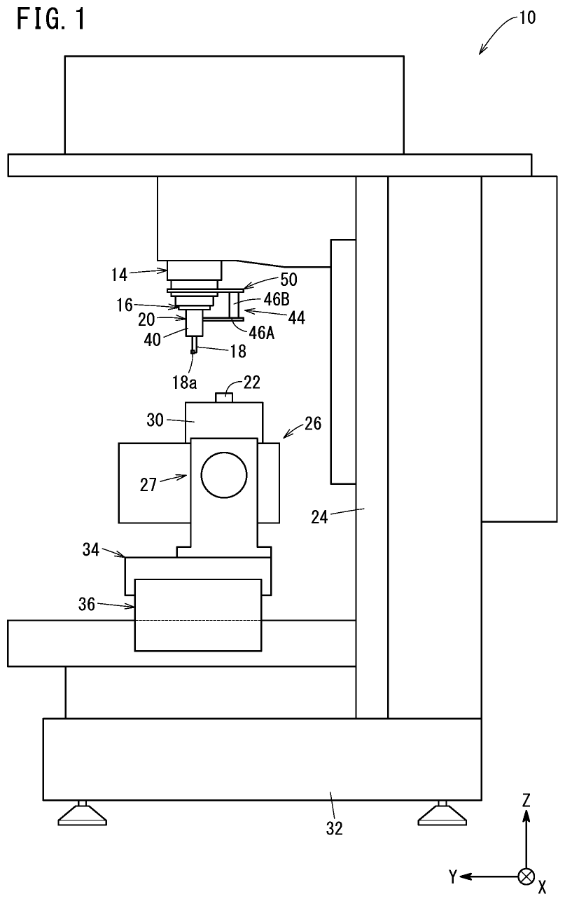

A machine tool according to a first embodiment will be described with reference to the drawings. FIG. 1 is a side view showing the machine tool according to the present embodiment.

A machine tool 10 carries out machining on an object to be machined 22, in other words, a workpiece, by means of a lathe machining tool 18 that is mounted on a spindle 16.

A spindle head 14 is provided on the machine tool 10. The spindle 16 is provided on the spindle head 14. A tool holder 20 for retaining the lathe machining tool 18 is detachably installed on the spindle 16. The spindle 16 is capable of imparting rotational motion to the tool, however, according to the present embodiment, the operation of the motor is stopped, and the lathe machining tool 18 is fixed by a fixing member 50 described later. Moreover, although an example in which only one spindle head 14 is provided is shown in FIG. 1, a plurality of the spindle heads 14 may be provided. In addition, the spindle 16 may be provided for each of the plurality of spindle heads 14. In this case, a plurality of the spindles 16 having similar specifications may be provided, or a plurality of the spindles 16 having different specifications may be provided. Further, the spindle 16 is not limited to any particular type of spindle, and for example, may be an air spindle or the like.

The machine tool 10 is equipped with a column 24 that causes the spindle head 14 to move in an upper/lower direction, an additional axis device 26 that rotatably supports the object to be machined 22, and a table 34 that causes the additional axis device 26 to move in a first direction and a second direction. The first direction and the second direction are perpendicular to each other. The first direction is a Y direction and the second direction is an X direction. Further, a direction perpendicular to the Y direction and the X direction is defined as a Z direction. A downward direction in which gravity acts is a −Z direction, and an upward direction is a +Z direction. An axial direction of the spindle 16 is in parallel with the Z direction.

The additional axis device 26 is positioned below the spindle 16. The additional axis device 26 is equipped with a rotary table 30. The object to be machined 22 is fixed on the rotary table 30. The object to be machined 22 can be fixed to the rotary table 30, for example, by suction, but the present invention is not limited to this feature. The additional axis device 26 is equipped with a tilting mechanism 27 that tilts a rotary axis of the rotary table 30. The rotary table 30 can be tilted at an arbitrary angle by the tilting mechanism 27. The rotary axes that are added by the additional axis device 26 are a rotary axis that causes the rotary table 30 to rotate, and a rotary axis that causes the rotary table 30 to be tilted. More specifically, two rotary axes are added by the additional axis device 26.

The machine tool 10 is capable of carrying out three dimensional machining on the object to be machined 22, by moving the spindle 16 in the Z direction, moving the additional axis device 26 in the X direction and the Y direction, rotating the object to be machined 22 by the additional axis device 26, and tilting the rotary table 30.

The additional axis device 26 is supported by the table 34. The table 34 is supported by a saddle 36. The table 34 is equipped with a non-illustrated X-axis movement mechanism that causes the table 34 to move in the X direction with respect to the saddle 36. Therefore, the table 34 is capable of moving in the X-axis direction with respect to the saddle 36. The saddle 36 is supported by a bed 32. The saddle 36 is equipped with a non-illustrated Y-axis movement mechanism that causes the saddle 36 to move in the Y-axis direction with respect to the bed 32. Therefore, the saddle 36 is capable of moving in the Y-axis direction with respect to the bed 32. In this manner, the table 34 is capable of moving in the X and Y directions with respect to the bed 32. Mechanisms that are widely known can be used for the Y-axis movement mechanism and the X-axis movement mechanism.

A non-illustrated splash guard is provided on the machine tool 10. The splash guard surrounds a machining area of the machine tool 10. The splash guard serves to prevent cutting fragments including cutting chips, or a cutting fluid or the like, which are generated due to machining, from being scattered into the surrounding area. A non-illustrated nozzle through which the cutting fluid is discharged toward the lathe machining tool 18 during machining is provided in the machining area. The machine tool 10 according to the present embodiment is configured in the foregoing manner.

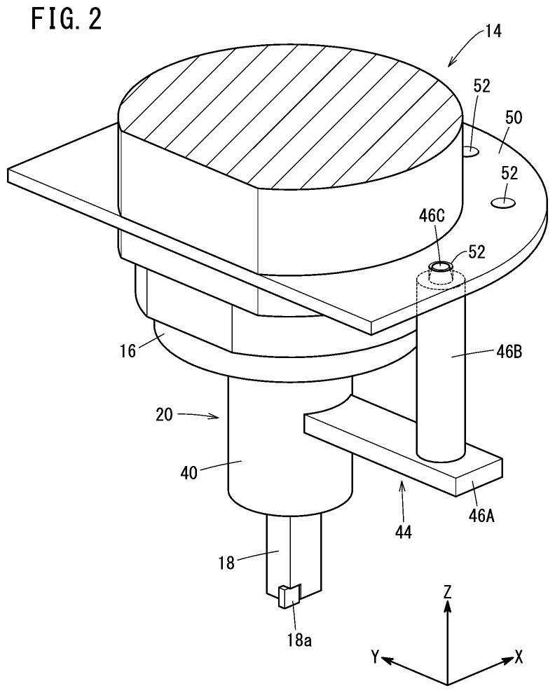

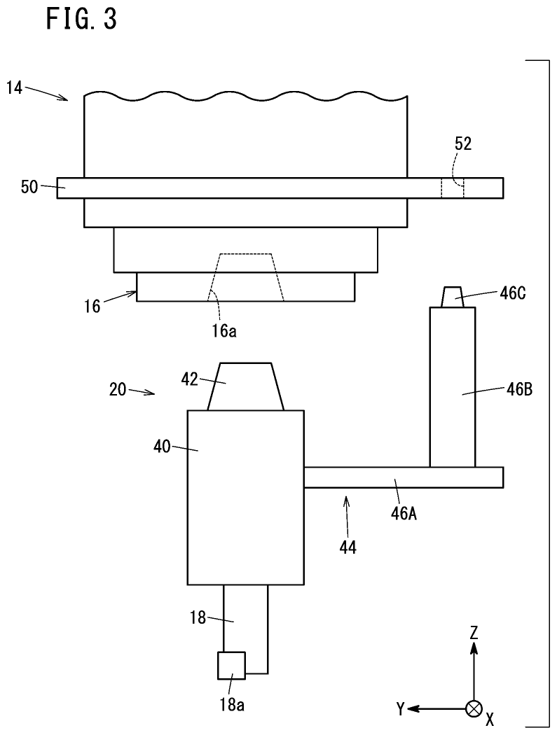

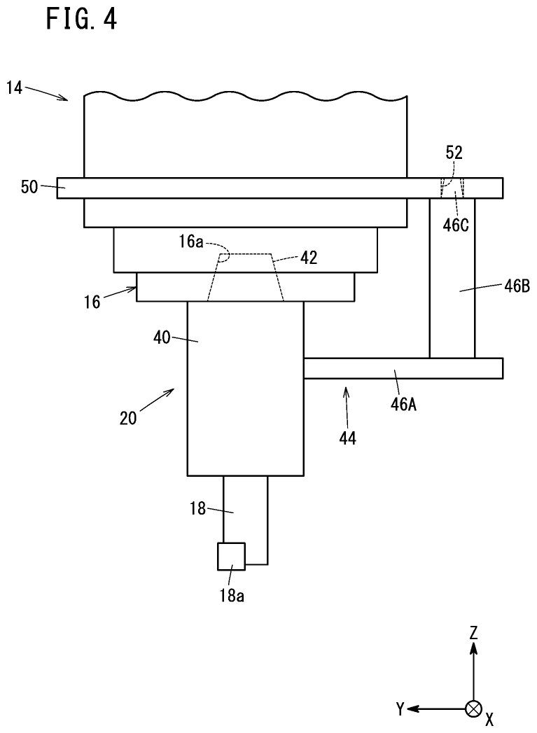

FIG. 2 is a perspective view showing a portion of the machine tool according to the present embodiment. FIG. 3 and FIG. 4 are side views showing a portion of the machine tool according to the present embodiment. The configuration in the vicinity of the spindle head 14 is shown in FIGS. 2 through 4. A state prior to the tool holder 20 being installed on the spindle 16 is shown in FIG. 3. A state after the tool holder 20 has been installed on the spindle 16 is shown in FIG. 2 and FIG. 4.

The tool holder (a retaining member) 20 retains the lathe machining tool 18 and is installed on the spindle 16. As shown in FIG. 3, the tool holder 20 includes a columnar shaped member 40, a protruding portion 42, and a mounting member 44. The protruding portion 42 is provided on one main surface of the columnar shaped member 40. The lathe machining tool 18 is provided on another main surface of the columnar shaped member 40. The protruding portion 42 protrudes in an axial direction of the lathe machining tool 18. A turning tip 18a, and more specifically, a cutting edge is provided, for example, on a distal end part of the lathe machining tool 18.

The fixing member 50 is provided on the spindle head 14. The fixing member 50 serves to fix the lathe machining tool 18, while enabling an angle of rotation (an indexing angle) of the lathe machining tool 18 to be adjusted. The fixing member 50 may be formed, for example, from a plate-shaped body whose normal direction is an axial direction of the spindle 16, but the present invention is not limited to this feature. As shown in FIG. 2, a plurality of holes 52, and more specifically, a plurality of through holes, are formed in the fixing member 50. Although only three holes 52 are shown in FIG. 2, the number of the holes 52 is not necessarily limited to three.

The mounting member 44 serves to mount the lathe machining tool 18 on the fixing member 50 at an adjusted angle of rotation. Since the lathe machining tool 18 is not only fixed to the spindle 16 via the tool holder 20, but the lathe machining tool 18 is also fixed to the fixing member 50 via the mounting member 44 provided on the tool holder 20, the turning tip 18a provided at a distal end of the lathe machining tool 18 is more satisfactorily fixed. As shown in FIG. 3, the mounting member 44 is equipped with a first portion 46A, a second portion 46B, and a third portion 46C. The first portion 46A protrudes from the tool holder 20 in a direction intersecting the axial direction of the lathe machining tool 18. More specifically, the first portion 46A protrudes from the tool holder 20 in a direction that is perpendicular to the axial direction of the lathe machining tool 18. As shown in FIG. 2, a planar shape of the first portion 46A, for example, is a rectangular shape, but the present invention is not limited to this feature. The columnar shaped member 40 and the first portion 46A may be formed integrally, or may be connected together by welding or the like. Further, the first portion 46A may be capable of being removed from the columnar shaped member 40. The first portion 46A may be fixed to the columnar shaped member 40 by forming an internal thread on the columnar shaped member 40, for example, by forming an external thread on a distal end of the first portion 46A, for example, and by screw-engaging the external thread into the internal thread. When the angle of rotation of the lathe machining tool 18 is adjusted, the first portion 46A rotates integrally with the columnar shaped member 40 about a central axis of the lathe machining tool 18.

The second portion 46B protrudes from the first portion 46A. A longitudinal direction of the second portion 46B, and specifically, the direction in which the second portion 46B protrudes, is a direction that intersects the longitudinal direction of the first portion 46A. More specifically, the direction in which the second portion 46B protrudes is parallel with the axial direction of the lathe machining tool 18. In other words, the direction in which the second portion 46B protrudes is the same as the direction in which the protruding portion 42 protrudes. The second portion 46B is formed, for example, in a columnar shape, and more specifically in a circular columnar shape, but the present invention is not limited to this feature. A lower end of the second portion 46B is fixed to the first portion 46A. The distance between the central axis of the lathe machining tool 18 and the central axis of the second portion 46B is equivalent to the distance between the central axis of the spindle 16 and the central axis of the holes 52. The first portion 46A and the second portion 46B may be formed integrally, or may be connected together by welding or the like. The second portion 46B may be capable of being removed from the first portion 46A. The second portion 46B may be fixed to the first portion 46A by forming an external thread on the first portion 46A, for example, by forming an internal thread on the second portion 46B, for example, and by screw-engaging the external thread into the internal thread. When the angle of rotation of the lathe machining tool 18 is adjusted, the second portion 46B rotates integrally with the first portion 46A about the central axis of the lathe machining tool 18.

The third portion 46C protrudes from the second portion 46B. The direction in which the third portion 46C protrudes, for example, is the same as the direction in which the protruding portion 42 protrudes. The third portion 46C is formed, for example, in the shape of a truncated cone, but the present invention is not limited to this feature. The area of an upper surface of the third portion 46C is set to be smaller than the area of a lower surface of the third portion 46C. The diameter of the lower surface of the third portion 46C is set to be equivalent to the diameter of the holes 52 provided in the fixing member 50, or to be slightly smaller than the diameter of the holes 52. A side surface of the third portion 46C is formed in a tapered shape. Since the side surface of the third portion 46C is formed in a tapered shape, insertion of the third portion 46C into the holes 52 is facilitated. The second portion 46B and the third portion 46C may be formed integrally, or may be connected together by welding or the like. The third portion 46C may be capable of being removed from the second portion 46B. The third portion 46C may be fixed to the second portion 46B by forming an external thread on a lower surface side of the third portion 46C, for example, by forming an internal thread on an upper end of the second portion 46B, for example, and by screw-engaging the external thread into the internal thread.

When the tool holder 20 is installed on the spindle 16, the protruding portion 42 is inserted into an installation hole 16a that is formed in a lower end part of the spindle 16.

When the protruding portion 42 is inserted into the installation hole 16a, the third portion 46C is inserted into any one of the plurality of holes 52. By the third portion 46C being inserted into the holes 52, the mounting member 44 is locked by the fixing member 50. Consequently, a state is brought about in which the mounting member 44 does not rotate about the central axis of the lathe machining tool 18. In other words, the mounting member 44 is fixed to the fixing member 50 in the holes 52. The angle of rotation of the lathe machining tool 18 differs depending on which one of the holes 52 the third portion 46C is inserted into. More specifically, the angle of rotation of the lathe machining tool 18 is adjusted in accordance with the location on the fixing member 50 where the mounting member 44 is mounted.

In the case it is desired to change the angle of rotation of the lathe machining tool 18, the tool holder 20 is removed from the spindle 16. When the tool holder 20 is t removed from the spindle 16, a state is brought about in which the third portion 46C is not inserted into the holes 52. When the tool holder 20 is installed again in a manner so that the third portion 46C is inserted into the hole 52 that differs from the hole 52 into which the third portion 46C was formerly inserted, the angle of rotation of the lathe machining tool 18 is changed. In this manner, when the tool holder 20 is installed, by appropriately selecting the hole 52 into which the third portion 46C is inserted, the angle of rotation of the lathe machining tool 18 is adjusted.

In the foregoing manner, according to the present embodiment, the fixing member 50 for fixing the lathe machining tool 18 while enabling the angle of rotation of the lathe machining tool 18 to be adjusted is provided on the spindle head 14, and the mounting member 44 for mounting the lathe machining tool 18 on the fixing member 50 at the adjusted angle of rotation is provided on the tool holder 20. According to the present embodiment, since the lathe machining tool 18 is not only fixed to the spindle 16 via the tool holder 20, but the lathe machining tool 18 is also fixed to the fixing member 50 via the mounting member 44 provided on the tool holder 20, the turning tip 18a provided at the distal end of the lathe machining tool 18 is more satisfactorily fixed. In addition, according to the present embodiment, the angle of rotation of the lathe machining tool 18 is adjusted in accordance with the location on the fixing member 50 where the mounting member 44 is mounted. Therefore, according to the present embodiment, it is possible to provide the machine tool 10, which is capable of preventing a decrease in the accuracy of the turning process, and is also capable of setting the angle of rotation of the lathe machining tool 18.

### Second Embodiment

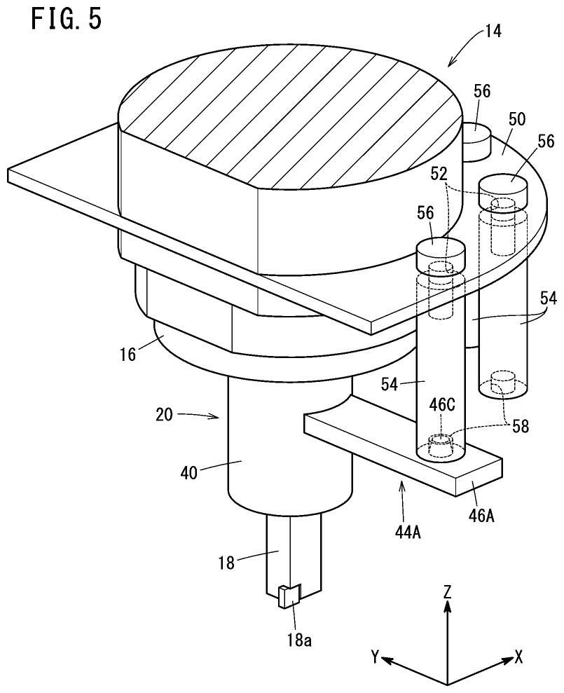

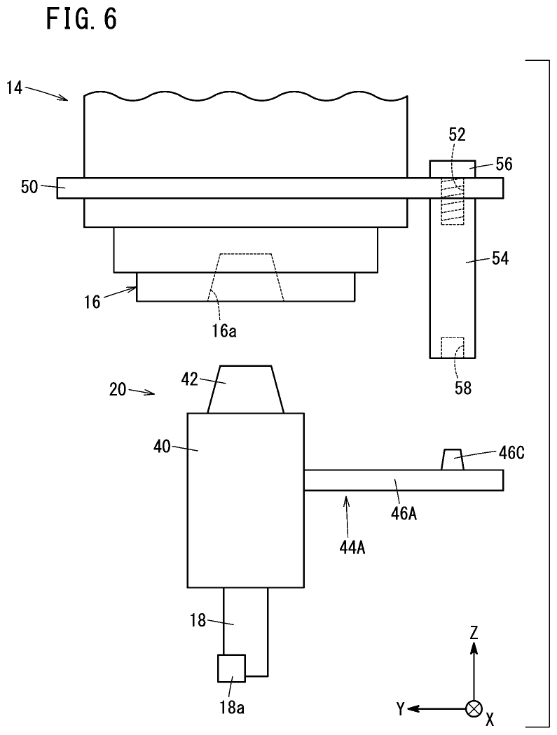

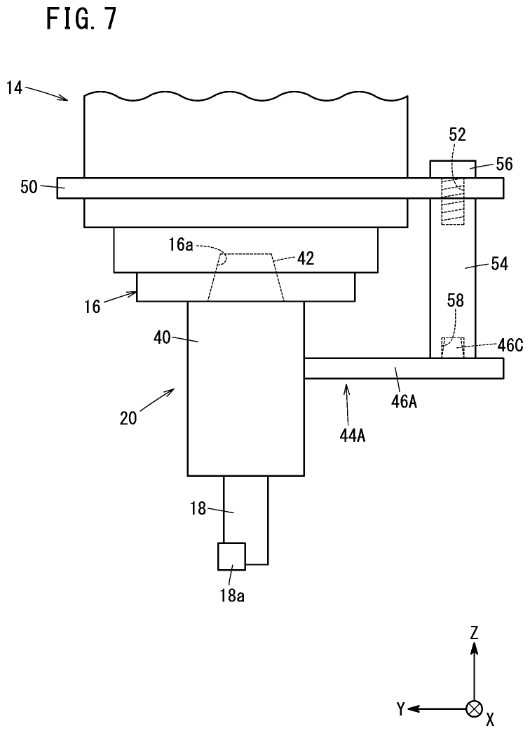

A machine tool according to a second embodiment will be described with reference to FIGS. 5 through 7. FIG. 5 is a perspective view showing a portion of the machine tool according to the present embodiment. FIG. 6 and FIG. 7 are side views showing a portion of the machine tool according to the present embodiment. A state prior to the tool holder 20 being installed on the spindle 16 is shown in FIG. 6. A state after the tool holder 20 has been installed on the spindle 16 is shown in FIG. 5 and FIG. 7. The same constituent elements as those of the machine tool according to the first embodiment shown in FIGS. 1 through 4 are designated by the same reference numerals, and description thereof will be omitted or referred to in an abbreviated manner.

In the machine tool 10 according to the present embodiment, a plurality of connecting members 54 are provided in the fixing member 50, and a mounting member 44A is fixed to the fixing member 50 via any one of the plurality of connecting members 54.

As shown in FIG. 6, in the present embodiment, the mounting member 44A is constituted by the first portion 46A, and the third portion 46C. The third portion 46C protrudes from the first portion 46A.

As shown in FIG. 5, the fixing member 50 is equipped with the plurality of connecting members 54. The plurality of connecting members 54 protrude from the fixing member 50 in a direction toward the mounting member 44A. The plurality of connecting members 54 are fixed, for example, in the plurality of holes 52, respectively. The connecting members 54 are fixed to the fixing member 50, for example, using bolts 56, but the present invention is not limited to this feature. The connecting members 54 may be fixed to the fixing member 50 by forming an external thread on the connecting members 54, for example, by forming an internal thread on the fixing member 50, for example, and by screw-engaging the external thread into the internal thread. Further, the fixing member 50 and the connecting members 54 may be formed integrally, or may be connected together by welding or the like. Holes 58 are formed in lower end parts of the connecting members 54. The third portion 46C is inserted into the holes 58. The diameter of the holes 58 is set to be equivalent to the diameter of the lower surface of the third portion 46C, or to be slightly larger than the diameter of the lower surface of the third portion 46C.

When the tool holder 20 is installed on the spindle 16, the protruding portion 42 is inserted into the installation hole 16a that is formed in the lower end part of the spindle 16 and the third portion 46C is inserted into the hole 58 of any one of the plurality of connecting members 54. By the third portion 46C being inserted into the holes 58, the mounting member 44A is locked by the fixing member 50 via the connecting members 54. Consequently, a state is brought about in which the mounting member 44A does not rotate about the central axis of the lathe machining tool 18. The angle of rotation of the lathe machining tool 18 differs depending on which one of the connecting members 54 the third portion 46C is engaged with. More specifically, the angle of rotation of the lathe machining tool 18 is adjusted in accordance with the location on the fixing member 50 where the mounting member 44A is mounted.

In the case it is desired to change the angle of rotation of the lathe machining tool 18, the tool holder 20 is removed from the spindle 16. When the tool holder 20 is removed from the spindle 16, a state is brought about in which the third portion 46C is not inserted into the holes 58. When the tool holder 20 is installed again in a manner so that the mounting member 44A is engaged with the connecting member 54 that differs from the connecting member 54 with which the mounting member 44A was formerly engaged, the angle of rotation of the lathe machining tool 18 changes. In this manner, when the tool holder 20 is installed, by appropriately selecting the connecting member 54 with which the mounting member 44A is engaged, the angle of rotation of the lathe machining tool 18 is adjusted.

In this manner, according to the present embodiment, the plurality of connecting members 54 are provided in the fixing member 50, and the mounting member 44A is fixed to the fixing member 50 via any one of the plurality of connecting members 54. In the present embodiment as well, since the lathe machining tool 18 is not only fixed to the spindle 16 via the tool holder 20, but the lathe machining tool 18 is also mounted on the fixing member 50 via the mounting member 44A provided on the tool holder 20, the turning tip 18a provided at the distal end of the lathe machining tool 18 is satisfactorily fixed. In addition, the angle of rotation of the lathe machining tool 18 is adjusted in accordance with the location of the connecting member 54 with which the mounting member 44A is engaged. Therefore, in the present embodiment as well, it is possible to provide the machine tool 10, which is capable of preventing a decrease in the accuracy of the turning process, and is also capable of setting the angle of rotation of the lathe machining tool 18.

### Third Embodiment

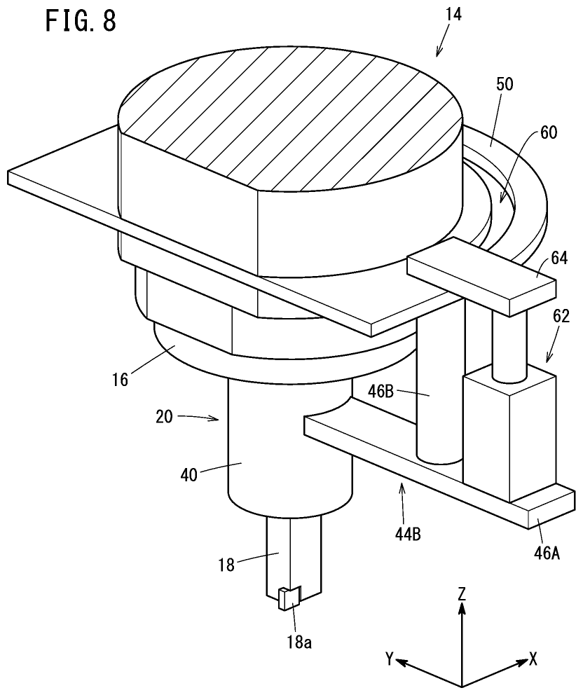

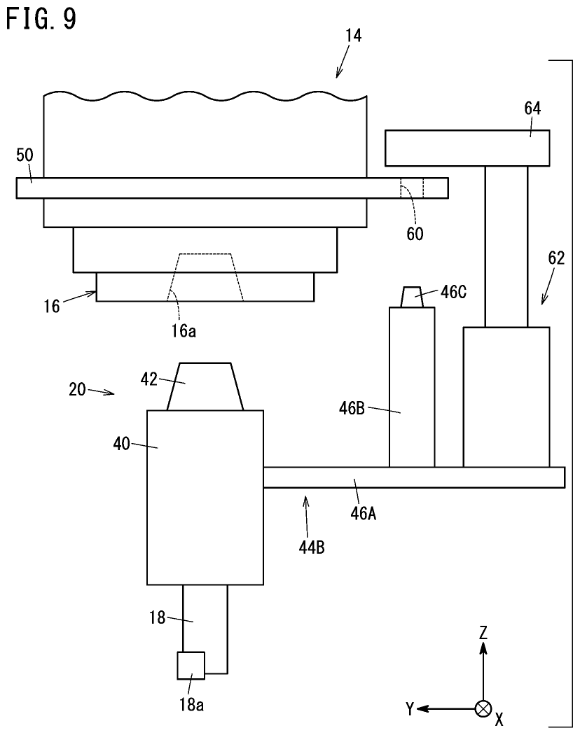

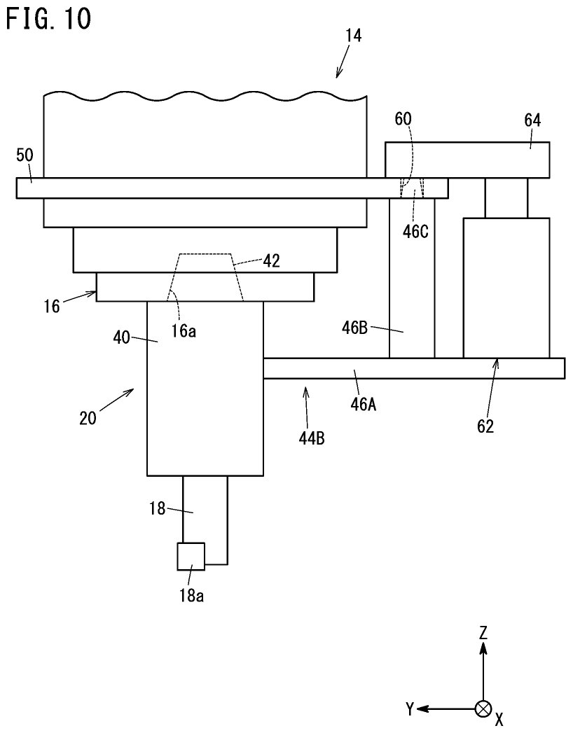

A machine tool according to a third embodiment will be described with reference to FIGS. 8 through 10. FIG. 8 is a perspective view showing a portion of the machine tool according to the present embodiment. FIG. 9 and FIG. 10 are side views showing a portion of the machine tool according to the present embodiment. A state prior to the tool holder 20 being installed on the spindle 16 is shown in FIG. 9. A state after the tool holder 20 has been installed on the spindle 16 is shown in FIG. 8 and FIG. 10. The same constituent elements as those of the machine tools according to the first and second embodiments shown in FIGS. 1 through 7 are designated by the same reference numerals, and description thereof will be omitted or referred to in an abbreviated manner.

In the machine tool 10 according to the present embodiment, the fixing member 50 is equipped with an arcuate slit 60, and a mounting member 44B is fixed to the fixing member 50 in the slit 60.

As shown in FIG. 9, in the present embodiment, the mounting member 44B is constituted by the first portion 46A, the second portion 46B, and the third portion 46C. According to the present embodiment, the first portion 46A is formed to be longer, and a clamping device 62 is fixed on the first portion 46A.

The clamping device 62 serves to fix the mounting member 44B to the fixing member 50 at an arbitrary location within the slit 60. As the clamping device 62, for example, a hydraulic clamping device or the like can be used, but the present invention is not limited to this feature. A rod 64 is provided on the clamping device 62. The clamping device 62 is capable of displacing the rod 64 in an upper/lower direction.

The installation of the tool holder 20 on the spindle 16 is performed, for example, in the following manner. More specifically, in a state in which the rod 64 of the clamping device 62 is raised, the protruding portion 42 is inserted into the installation hole 16a formed in the lower end part of the spindle 16, and the third portion 46C is inserted into the arcuate slit 60 that is formed in the fixing member 50. Thereafter, by lowering the rod 64 of the clamping device 62, the fixing member 50 is sandwiched between the second portion 46B of the mounting member 44B and the rod 64 of the clamping device 62. Consequently, the mounting member 44B is fixed to the fixing member 50, and a state is brought about in which the mounting member 44B does not rotate about the central axis of the lathe machining tool 18. The angle of rotation of the lathe machining tool 18 differs depending on the location within the arcuate slit 60 at which the mounting member 44B is fixed to the fixing member 50. More specifically, the angle of rotation of the lathe machining tool 18 is adjusted in accordance with the location on the fixing member 50 where the mounting member 44B is mounted.

In the case it is desired to change the angle of rotation of the lathe machining tool 18, the rod 64 of the clamping device 62 is raised. When the rod 64 of the clamping device 62 is raised, a state is brought about in which the mounting member 44B is not fixed to the fixing member 50. Consequently, the angle of rotation of the lathe machining tool 18 can be changed. After the angle of rotation of the lathe machining tool 18 has been changed, the rod 64 of the clamping device 62 is lowered. By lowering the rod 64 of the clamping device 62, the fixing member 50 is sandwiched between the second portion 46B of the mounting member 44B and the rod 64 of the clamping device 62. Consequently, the mounting member 44B is fixed to the fixing member 50, and a state is brought about in which the mounting member 44B does not rotate about the central axis of the lathe machining tool 18. In this manner, the angle of rotation of the lathe machining tool 18 is changed.

In the foregoing manner, according to the present embodiment, the fixing member 50 is equipped with the arcuate slit 60, and the mounting member 44B is fixed to the fixing member 50 in the slit 60. In the present embodiment as well, since the lathe machining tool 18 is not only fixed to the spindle 16 via the tool holder 20, but the lathe machining tool 18 is also mounted on the fixing member 50 via the mounting member 44B provided on the tool holder 20, the turning tip 18a provided at the distal end of the lathe machining tool 18 is satisfactorily fixed. In accordance with the present embodiment, since the mounting member 44B can be fixed to the fixing member 50 at an arbitrary location within the slit 60, it becomes possible to perform a fine adjustment of the angle of rotation of the lathe machining tool 18.

### Fourth Embodiment

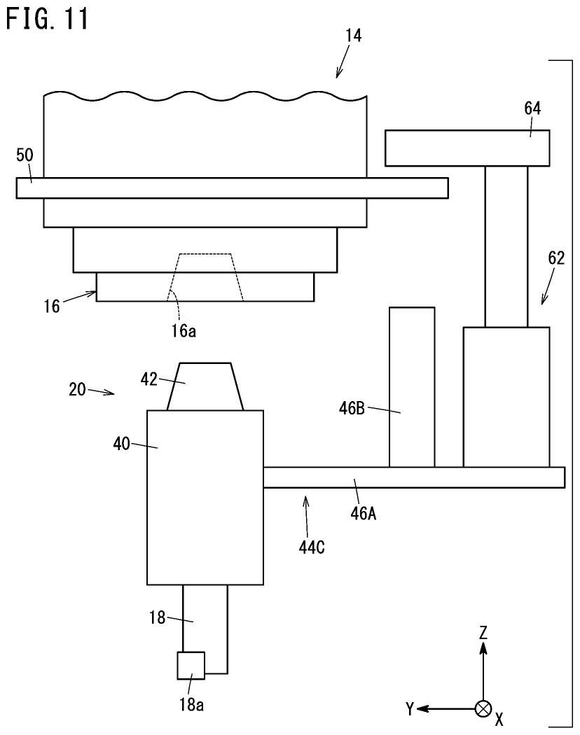

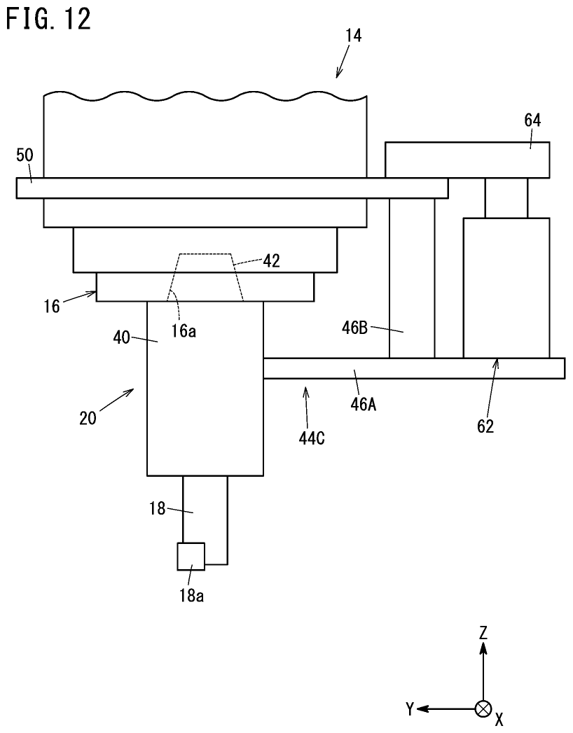

A machine tool according to a fourth embodiment will be described with reference to FIG. 11 and FIG. 12. FIG. 11 and FIG. 12 are side views showing a portion of the machine tool according to the present embodiment. A state prior to the tool holder 20 being installed on the spindle 16 is shown in FIG. 11. A state after the tool holder 20 has been installed on the spindle 16 is shown in FIG. 12. The same constituent elements as those of the machine tools according to the first through third embodiments shown in FIGS. 1 through 10 are designated by the same reference numerals, and description thereof will be omitted or referred to in an abbreviated manner.

In the machine tool 10 according to the present embodiment, the arcuate slit 60 (see FIG. 8) is not provided in the fixing member 50. In the present embodiment as well, in the same manner as in the third embodiment, a mounting member 44C is fixed to the fixing member 50 by the clamping device 62.

As shown in FIG. 11, in the present embodiment, the mounting member 44C is constituted by the first portion 46A and the second portion 46B. In the present embodiment as well, in the same manner as in the third embodiment, the first portion 46A is formed to be longer, and the clamping device 62 is provided on the first portion 46A.

The installation of the tool holder 20 on the spindle 16 is performed, for example, in the following manner. More specifically, in a state in which the rod 64 of the clamping device 62 is raised, the protruding portion 42 is inserted into the installation hole 16a that is formed in the lower end part of the spindle 16. Thereafter, by lowering the rod 64 of the clamping device 62, the fixing member 50 is sandwiched between the second portion 46B of the mounting member 44C and the rod 64 of the clamping device 62. Consequently, the mounting member 44C is fixed to the fixing member 50, and a state is brought about in which the mounting member 44C does not rotate about the central axis of the lathe machining tool 18. The angle of rotation of the lathe machining tool 18 differs depending on the location at which the mounting member 44C is fixed to the fixing member 50. More specifically, the angle of rotation of the lathe machining tool 18 is adjusted in accordance with the location on the fixing member 50 where the mounting member 44C is mounted.

In the case it is desired to change the angle of rotation of the lathe machining tool 18, the rod 64 of the clamping device 62 is raised. When the rod 64 of the clamping device 62 is raised, a state is brought about in which the mounting member 44C is not fixed to the fixing member 50. Consequently, the angle of rotation of the lathe machining tool 18 can be changed. After the angle of rotation of the lathe machining tool 18 has been changed, the rod 64 of the clamping device 62 is lowered. By lowering the rod 64 of the clamping device 62, the fixing member 50 is sandwiched between the second portion 46B of the mounting member 44C and the rod 64 of the clamping device 62. Consequently, the mounting member 44C is fixed to the fixing member 50, and a state is brought about in which the mounting member 44C does not rotate about the central axis of the lathe machining tool 18. In this manner, the angle of rotation of the lathe machining tool 18 is changed.

In the foregoing manner, the arcuate slit 60 need not necessarily be provided in the fixing member 50. In the present embodiment as well, since the lathe machining tool 18 is not only fixed to the spindle 16 via the tool holder 20, but the lathe machining tool 18 is also mounted on the fixing member 50 via the mounting member 44C provided on the tool holder 20, the turning tip 18a provided at the distal end of the lathe machining tool 18 is satisfactorily fixed. Further, in the present embodiment as well, the mounting member 44C is fixed to the fixing member 50 by the clamping device 62. Also in the present embodiment, since the mounting member 44C can be fixed at an arbitrary location, it becomes possible to perform a fine adjustment of the angle of rotation of the lathe machining tool 18.

### Modified Embodiments

Although preferred embodiments of the present invention have been described above, the present invention is not limited to the above-described embodiments, and various modifications are capable of being made thereto without departing from the essence and gist of the present invention.

For example, in the third embodiment, although an exemplary case has been described in which the mounting member 44B is fixed to the fixing member 50 by the clamping device 62, the present invention is not limited to this feature. The mounting member 44B may be fixed to the fixing member 50 using a fastening member other than the clamping device 62. The mounting member 44B may be fixed to the fixing member 50, for example, by forming an internal thread on an upper surface side of the third portion 46C, and by screw-engaging an external thread provided on a non-illustrated wing bolt or the like into the internal thread.

The above-described embodiments may be summarized in the following manner.

The machine tool (10) includes the spindle head (14) equipped with the spindle (16), the tool holder (20) that retains the lathe machining tool (18) and is installed on the spindle, the fixing member (50) provided on the spindle head and configured to fix the lathe machining tool while enabling the angle of rotation of the lathe machining tool to be adjusted, and the mounting member (44) provided on the tool holder and configured to mount the lathe machining tool on the fixing member at the adjusted angle of rotation, wherein the angle of rotation of the lathe machining tool is adjusted in accordance with the location on the fixing member where the mounting member is mounted. In accordance with such a configuration, since the lathe machining tool is not only fixed to the spindle via the tool holder, but the lathe machining tool is also mounted on the fixing member via the mounting member provided on the tool holder, the turning tip provided at the distal end of the lathe machining tool is satisfactorily fixed. In addition, in accordance with such a configuration, the angle of rotation of the lathe machining tool is adjusted in accordance with the location on the fixing member where the mounting member is mounted. Therefore, in accordance with such a configuration, it is possible to provide the machine tool, which is capable of preventing a decrease in the accuracy of the turning process, and is also capable of setting the angle of rotation of the lathe machining tool.

The fixing member may be a plate-shaped body whose normal direction is an axial direction of the spindle.

The plurality of holes (52) may be provided in the fixing member, and the mounting member may be fixed to the fixing member in any one of the plurality of holes.

The mounting member may include the first portion (46A) that protrudes from the tool holder in a direction intersecting the axial direction of the lathe machining tool, and the second portion (46B) that protrudes from the first portion toward the fixing member, and the second portion may be fixed to the fixing member.

The plurality of connecting members (54) may be provided in the fixing member, and the mounting member may be fixed to the fixing member via any one of the plurality of connecting members.

The arcuate slit (60) may be formed in the fixing member, and the mounting member may be fixed to the fixing member in the slit. In accordance with such a configuration, since the mounting member can be fixed at an arbitrary location within the slit, it becomes possible to perform a fine adjustment of the angle of rotation of the lathe machining tool.

The clamping device (62) may further be provided, and the mounting member may be fixed to the fixing member by the clamping device.

1. A machine tool comprising:
a spindle head equipped with a spindle;
a tool holder that is configured to retain a lathe machining tool and is installed on the spindle;
a fixing member provided on the spindle head and configured to fix the lathe machining tool while enabling an angle of rotation of the lathe machining tool to be adjusted; and
a mounting member provided on the tool holder and configured to mount the lathe machining tool on the fixing member at the angle of rotation that has been adjusted,
wherein the angle of rotation of the lathe machining tool is adjusted in accordance with a location on the fixing member where the mounting member is mounted.

2. The machine tool according to claim 1, wherein
the fixing member is a plate-shaped body whose normal direction is an axial direction of the spindle.

3. The machine tool according to claim 1, wherein:
a plurality of holes are provided in the fixing member; and
the mounting member is fixed to the fixing member in any one of the plurality of holes.

4. The machine tool according to claim 3, wherein:
the mounting member includes a first portion configured to protrude from the tool holder in a direction intersecting an axial direction of the lathe machining tool, and a second portion configured to protrude from the first portion toward the fixing member; and
the second portion is fixed to the fixing member.

5. The machine tool according to claim 3, wherein:
a plurality of connecting members are provided in the fixing member; and
the mounting member is fixed to the fixing member via any one of the plurality of connecting members.

6. The machine tool according to claim 1, wherein:
a slit having an arc shape is formed in the fixing member; and
the mounting member is fixed to the fixing member in the slit.

7. The machine tool according to claim 1, further comprising a clamping device, wherein
the mounting member is fixed to the fixing member by the clamping device.
